(19) United States
(12) Patent Application Publication
(10) Pub. No.: US 2025/0380022 A1
(43) Pub. Date: Dec. 11, 2025

(54) METHOD AND APPARATUS FOR INTERACTION IN A LIVE STREAMING, DEVICE, AND MEDIUM

(71) Applicant: Beijing Zitiao Network Technology Co., Ltd., Beijing (CN)

(72) Inventors: Ping ZENG, Beijing (CN); Bibo HE, Beijing (CN); Meng HE, Beijing (CN); Jianhua XU, Beijing (CN); Tongkai LI, Beijing (CN)

(21) Appl. No.: 19/228,479

(22) Filed: Jun. 4, 2025

(30) Foreign Application Priority Data
Jun. 6, 2024 (CN) 202410733546.1

(51) Int. Cl. H04N 21/431; H04N 21/2187; H04N 21/258

(52) U.S. Cl. CPC H04N 21/431; H04N 21/2187; H04N 21/25866

(57) ABSTRACT

Examples of the disclosure relate to a method and apparatus for interaction in a live streaming, a device, and a medium. The method comprises: displaying, in response to a sending operation on a target virtual resource, at least one display change type corresponding to the target virtual resource; obtaining, in response to a selecting operation on a target display change type, a display change policy and current association information corresponding to the target display change type; and sending the target virtual resource to a user in the live streaming, and displaying the target virtual resource on the live streaming interface.

### CROSS-REFERENCE TO RELATED APPLICATION

This application claims priority to Chinese Application No. 202410733546.1 filed on Jun. 6, 2024, the disclosure of which is incorporated herein by reference in its entirety:

### FIELD

The disclosure relates to the technical field of live streaming, and particularly relates to a method and apparatus for interaction in a live streaming, a device, and a medium.

### BACKGROUND

As the technology of live streaming keeps developing, a user can interact with a streamer while watching a live streaming. Typically, during a live streaming, a virtual resource can be given by the user as a gift to the streamer and displayed on a live streaming interface.

### SUMMARY

The disclosure provides a method and apparatus for interaction in a live streaming, a device, and a medium.

Examples of the disclosure provide a method for interaction in a live streaming. The method includes:
displaying, in response to a sending operation on a target virtual resource on a live streaming interface, at least one display change type corresponding to the target virtual resource;
obtaining, in response to a selecting operation on a target display change type in the at least one display change type, a display change policy and current association information corresponding to the target display change type; and
sending the target virtual resource to a user in the live streaming, and displaying the target virtual resource on the live streaming interface based on the display change policy according to the current association information of the target display change type.

The examples of the disclosure further provide an apparatus for interaction in a live streaming. The apparatus includes:
a displaying module configured to display, in response to a sending operation on a target virtual resource on a live streaming interface, at least one display change type corresponding to the target virtual resource;
an obtaining module configured to obtain, in response to a selecting operation on a target display change type in the at least one display change type, a display change policy and current association information corresponding to the target display change type; and
a sending module configured to send the target virtual resource to a user in the live streaming, and displaying the target virtual resource on the live streaming interface based on the display change policy according to the current association information of the target display change type.

The examples of the disclosure further provide an electronic device. The electronic device includes: a processor, and a memory configured to store a processor-executable instruction. The processor is configured to read the executable instruction from the memory and execute the instruction to implement the method for interaction in a live streaming according to the examples of the disclosure.

The examples of the disclosure further provide a computer-readable storage medium. The storage medium stores a computer program. The computer program is configured to execute the method for interaction in a live streaming according to the examples of the disclosure.

### BRIEF DESCRIPTION OF THE DRAWINGS

The above and other features, advantages, and aspects of examples of the disclosure will become more apparent with reference to the following particular embodiments in conjunction with the drawings. The same or similar reference numerals refer to the same or similar elements throughout the drawings. It should be understood that the drawings are schematic, and that the parts and elements are not necessarily drawn to scale.

FIG. 1 is a schematic flowchart of a method for interaction in a live streaming according to an example of the disclosure;

FIG. 2 is a schematic diagram of a live streaming interface according to an example of the disclosure;

FIG. 3 is a schematic diagram of another live streaming interface according to an example of the disclosure;

FIG. 4 is a schematic diagram of an interaction process in a live streaming according to an example of the disclosure;

FIG. 5 is a schematic structural diagram of an apparatus for interaction in a live streaming according to an example of the disclosure; and

FIG. 6 is a schematic structural diagram of an electronic device according to an example of the disclosure.

### DETAILED DESCRIPTION OF EMBODIMENTS

Examples of the disclosure are described in more detail below with reference to the drawings. Although some examples of the disclosure are shown in the drawings, it should be understood that the disclosure may be embodied in various forms and should not be construed as being limited to the examples set forth herein. On the contrary; these examples are provided, such that the disclosure will be understood more thoroughly and completely. It should be understood that the drawings and examples of the disclosure are for illustrative purposes merely and are not intended to limit the scope of protection of the disclosure.

It should be understood that various steps recited in the method embodiments of the disclosure can be executed in different orders and/or in parallel. Furthermore, the method embodiments can include additional steps and/or omit to execute the illustrated steps. The scope of the disclosure is not limited in this respect.

As used herein, the term “comprise” or “include” and their variations are open-ended, that is, “comprise but not limited to” and “include but not limited to”. The term “based on” is “based at least in part on”. The term “an example” means “at least one example”. The term “another example” means “at least one further example”. The term “some examples” means “at least some examples”. Definitions for other terms are given in the description below.

It should be noted that concepts such as “first” and “second” mentioned in the disclosure are merely used to distinguish different apparatuses, modules or units, and are not used to limit the order of functions executed by these apparatuses, modules or units or their interdependence.

It should be noted that the modification with “a”. “an” or “a plurality of” in the present disclosure is intended to be illustrative rather than limitative, and should be understood by those skilled in the art as “one or more” unless the context clearly dictates otherwise.

The names of messages or information exchanged between a plurality of apparatuses in the embodiments of the disclosure are merely for illustrative purposes, and are not intended to limit the scope of these messages or information.

Changes of display forms of virtual resources given by different users are limited in the related art, and thus cannot satisfy interaction demand of giving a gift by the user in the live streaming.

Compared with the prior art, the technical solution according to the examples of the disclosure has the advantages as follows: the solution for interaction in a live streaming includes: displaying, in response to a sending operation on a target virtual resource on a live streaming interface, at least one display change type corresponding to the target virtual resource; obtaining, in response to a selecting operation on a target display change type in the at least one display change type, a display change policy and current association information corresponding to the target display change type; and sending the target virtual resource to a user in the live streaming, and displaying the target virtual resource on the live streaming interface based on the display change policy according to the current association information of the target display change type. By using the technical solution, at least one display change type corresponding to the sending operation on the target virtual resource by the user on the live streaming interface can be displayed. Then the current association information and the display change policy of the target display change type selected from the at least one display change type are obtained. The target virtual resource is sent to the user in the live streaming, and the target virtual resource is displayed based on the display change policy according to the current association information of the target display change type. In a live streaming scenario, by setting the display change type for the user to select, the user can decide a change manner of the sent virtual resource during display. Compared with the related art, when the virtual resource is sent, multi-form display can be implemented according to a form change manner determined by the user, such that diversity: richness and interest of giving a gift by the user in the live streaming are enhanced, and an interactive experience effect in the live streaming is further improved.

In order to solve the problem of limited display forms of virtual resources given in a live streaming scenario in the related art, the example of the disclosure provide a method for interaction in a live streaming. The method is described below in combination with specific examples.

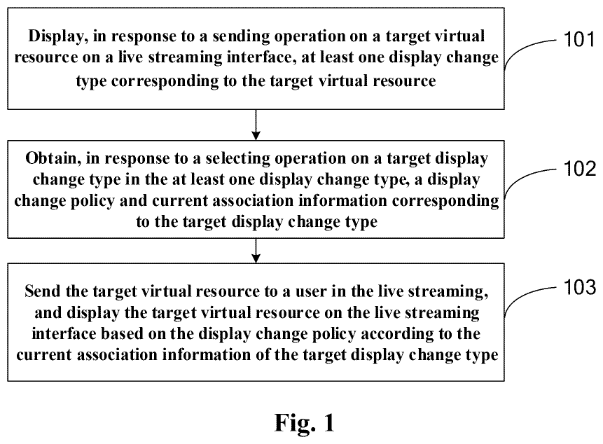

FIG. 1 is a schematic flowchart of a method for interaction in a live streaming according to an example of the disclosure. The method may be executed by an apparatus for interaction in a live streaming. The apparatus may be implemented by software and/or hardware, and may generally be integrated into an electronic device. As shown in FIG. 1, the method includes:

Step 101, in response to a sending operation on a target virtual resource on a live streaming interface, at least one display change type corresponding to the target virtual resource is displayed.

The method for interaction in a live streaming in the example of the disclosure is applied to a current client side where a current viewer user watching the live streaming is located. The live streaming interface may be a page for displaying a live room of a streamer user. The live streaming interface may be displayed through a webpage or an application program page. The streamer user may be an initiating user performing the live streaming.

The virtual resources may be resources that may be transferred from one user to another in the live room. The virtual resources may include virtual flowers, virtual hearts, etc. The virtual resources may be given to the streamer user by the viewer user of the live streaming interface. The target virtual resource may be a virtual resource corresponding to the sending operation performed by the current viewer user on the live streaming interface. The display change type may represent a display style or a display form change manner when the virtual resource is displayed after being sent. The virtual resource may be displayed in a plurality of different display styles under each display change type and may be displayed in a changing manner according to some rules or policies. One or more display change types may be set, which is not specifically limited. The display change types in the example of the disclosure may include at least one of the following: time, relation information between a viewer user and a streamer user, live streaming information of the streamer user, and randomization.

When the display change type is the time, the virtual resource may be changed in different display styles according to display change policies corresponding to factors such as time periods, seasons or holidays corresponding to a time point of the sending operation on the virtual resource. When the display change type is the relation information between a viewer user and a streamer user, the virtual resource may be changed in different display styles according to display change policies corresponding to different relations between the viewer users who send the virtual resource and the streamer user. When the display change type is the live streaming information of the streamer user, the virtual resource may be changed in different display styles according to display change policies corresponding to different live streaming information of the streamer user. When the display change type is randomization, the virtual resource may be changed in different display styles randomly.

The apparatus for interaction in a live streaming may display at least one virtual resource in response to a trigger operation of the current viewer user on a gift-giving control on the live streaming interface, then receive a first trigger operation of the current viewer user on the target virtual resource of the at least one virtual resource, determine that the sending operation of the current viewer user sending the target virtual resource to the streamer user is received, and display at least one display change type corresponding to the target virtual resource. Herein, the first trigger operation may be, for example, a long press.

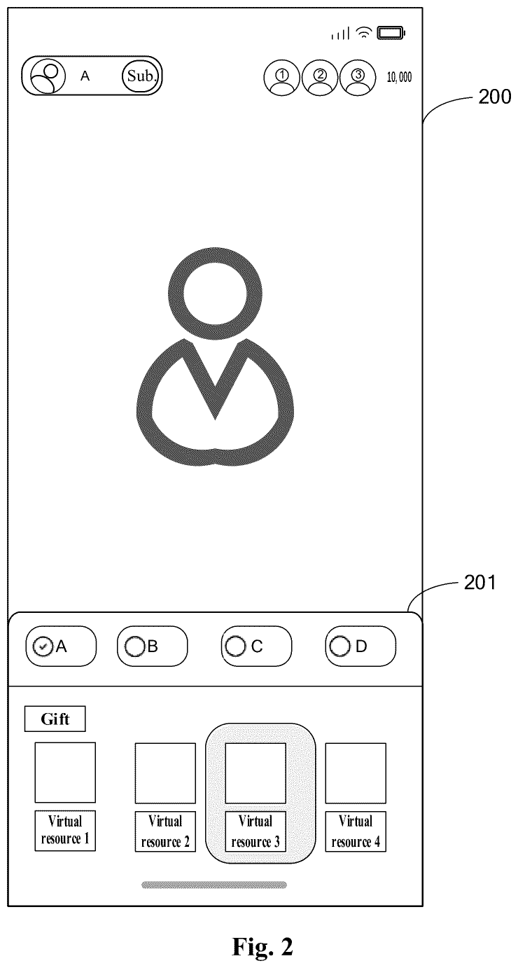

Illustratively, FIG. 2 is a schematic diagram of a live streaming interface according to an example of the disclosure. As shown in FIG. 2, a live streaming interface 200 of the current client side is shown. The live streaming interface 200 includes four virtual resources. The virtual resource 3 may be used as a target virtual resource when triggered by the current viewer user. At least one display change type corresponding to the target virtual resource may be displayed in an area 201. For example, in the figure, the live streaming interface includes four display change types A, B, C and D.

Step 102, in response to a selecting operation on a target display change type in the at least one display change type, a display change policy and current association information corresponding to the target display change type are obtained.

The association information may be required related information influencing display of virtual resources and corresponding to the display change type. Different display change types correspond to different association information. The current association information may correspond to a target display change type.

In some examples, in a case that the target display change type is the time, the current association information is a time point at which the sending operation on the target virtual resource is performed. In a case that the target display change type is the relation information between the viewer user and the streamer user, the current association information includes a current attribute value of a current viewer user to the streamer user and/or current subscription information of the current viewer user to the streamer user. In a case that the target display change type is the live streaming information of the streamer user, the current association information is current live streaming data of the streamer user. When the target display change type is randomization, the current association information may be set to null.

The relation information between a viewer user and a streamer user may include an attribute value of the viewer user to the streamer user and/or subscription information of the viewer user to the streamer user. The attribute value of the viewer user to the streamer user may be a value reflecting a support degree or an activity degree of the viewer user to the streamer user, and the current association information includes a corresponding current attribute value of a current viewer user to the streamer user. The subscription information of the viewer user to the streamer user may be information indicating whether the viewer user and the streamer user are subscribed (sub.), and may include three types of no subscription between the viewer user and the streamer user, unidirectional subscription of the viewer user to the streamer user, and mutual subscription between the viewer user and the streamer user. The current association information may include current subscription information of the current viewer user to the streamer user. The current subscription information is one of the above types. The live streaming information of the streamer user may include live streaming data of the streamer user. The live streaming data may include at least one of a live streaming progress, a number of live streaming viewers, and live streaming popularity ranking. The current association information may be the current live streaming data of the streamer user. The current live streaming data may be live streaming data when the sending operation on the target virtual resource is performed or live streaming data when the target virtual resource is displayed.

The display change policy may be a configuration file that is set for the display change types and may control the display form of the sent virtual resource to change with the association information. The display change policy is configured to set display attributes of the target virtual resource corresponding to at least one piece of association information of each display change type. Each display change type may correspond to at least one piece of association information. Different association information may set different display attributes for the virtual resource, so as to achieve that when the display change type and/or the association information is different, the virtual resource changes in different display styles according to different display attributes. The display attribute of the target virtual resource may include at least one of the following: color, transparency, brightness, and a display style of at least one sub-area. The color may include a plurality of colors. The transparency may range from opaque to completely opaque. The sub-area may be a partial region included in the target virtual resource. For example, the target virtual resource is a virtual flower, the sub-area may be a petal, and may include a plurality of petals. The display style may be a specific attribute of the sub-area when displayed, and the display style may also include the color, the transparency, etc.

Specifically, after the apparatus for interaction in a live streaming displays at least one display change type, each display change type may be represented by one selection control. When a selecting operation on one of the display change types is received, the display change type is determined as the target display change type. With reference to FIG. 2, display change type A in FIG. 2 is selected by a current viewer user, and the display change type A is the target display change type. Then, the current association information corresponding to the target display change type may be obtained. The display change policy corresponding to the target display change type may be obtained from a server side or obtained locally for subsequent use.

Step 103, the target virtual resource is sent to a user in the live streaming, and the target virtual resource is displayed on the live streaming interface based on the display change policy according to the current association information of the target display change type.

The current client side may be a client side where the current viewer user is located. The live streaming side may be a client side where the streamer user is located. The other client sides may include client sides where other viewer users except for the current viewer user in the plurality of watching viewer users are located.

Specifically, the apparatus for interaction in a live streaming may send the target virtual resource to the streamer user, that is, adjust the target virtual resource from binding to the current viewer user to binding to the streamer user, so as to complete an operation of giving a gift, and display the target virtual resource on the live streaming interface according to the current association information of the target display change type and the display change policy. The target virtual resource is changed according to the display change policy under the target display change type selected by the current viewer user and different current association information. The apparatus for interaction in a live streaming receives a second trigger operation by the current viewer user on the target virtual resource. The second trigger operation may be an operation except for the first trigger operation, and may directly send the target virtual resource to the streamer user, and set a current display attribute of the target virtual resource as a default attribute for display. The default attribute may be a display attribute of the virtual resource when the viewer user does not select a display change type, and a specific setting may be based on an actual situation.

Moreover, the apparatus for interaction in a live streaming may send the target display change type, the current association information, and the display change policy to the server side, such that the server side sends the target display change type, the current association information, and the display change policy to the live streaming side and other client sides. In the live streaming interface the live streaming side and the other client sides may also display the target virtual resource on the live streaming interface based on the display change policy according to the current association information of the target display change type.

In some examples, the target virtual resource is displayed on the live streaming interface of a current client side based on the display change policy according to the current association information of the target display change type as follows: Search is performed in the display change policy according to the current association information of the target display change type, and a current display attribute of the target virtual resource corresponding to the current association information is extracted; and the target virtual resource is displayed according to the current display attribute.

The current display attribute may be a display attribute of the target virtual resource corresponding to the current association information and defined in the display change policy. For example, assuming that the target display change type is the time, the current association information is a time point of the sending operation, the time point corresponds to summer, and the display attribute of the target virtual resource corresponding to summer may include a color of red. In this case, the current display attribute is red, which is only an instance.

The apparatus for interaction in a live streaming may extract policies corresponding to the display change policy according to the target display change type, search in these policies merely according to the current association information, extract the current display attribute corresponding to the current association information, and set the target virtual resource to be the current display attribute for display on the live streaming interface.

Illustratively, in a case that the target display change type is the time, the current association information is a time point at which the sending operation on the target virtual resource is performed. The target virtual resource may be displayed according to display attributes corresponding to factors such as a season, a time period or a holiday at the time point, thus an effect that the target virtual resource has different display forms when sent at different time is achieved. In a case that the target display change type is the relation information between the viewer user and the streamer user, the current association information includes a current attribute value and/or current subscription information of a current viewer user to the streamer user. The target virtual resource may be displayed according to the current attribute value and/or a display attribute corresponding to the current subscription information, such that an effect is achieved that when a viewer user has different relation information with the streamer user, the target virtual resource sent by the viewer user has a different display form. In a case that the target display change type is the live streaming information of the streamer user. the current association information is current live streaming data of the streamer user. The target virtual resource may be displayed according to a display attribute corresponding to the current live streaming data, such that an effect is achieved that when the streamer user has a different live streaming data, the target virtual resource has a different display form. When the target display change type is randomization, the target virtual resource may be displayed according to possessed display attributes randomly. Possessed display forms of the target virtual resource may be displayed randomly.

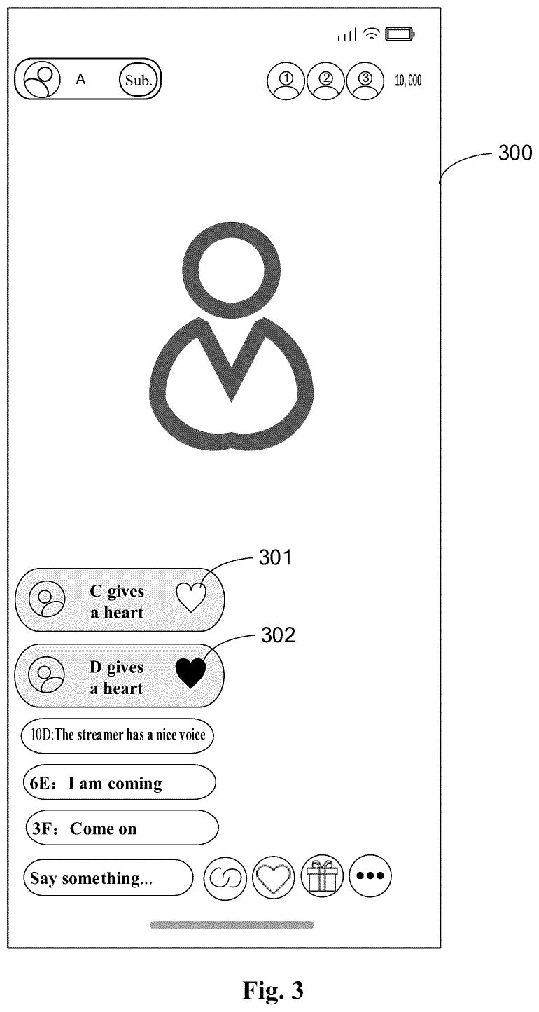

Illustratively, FIG. 3 is a schematic diagram of another live streaming interface according to an example of the disclosure. As shown in FIG. 3, a live streaming interface 300 of a current client side is shown. The live streaming interface 300 includes a target virtual resource 301 sent by the current viewer user to the streamer user and a target virtual resource 302 sent by another viewer user to the streamer user. The target virtual resource 301 is a virtual white heart. The target virtual resource 302 is a virtual black heart. The target virtual resource 301 and the target virtual resource 302 are the same virtual resource sent to the streamer user by two different viewer users at different time points, and the colors are different, which are only examples.

According to the disclosure, a sent virtual resource may be displayed according to specific association information and a display change policy by a user selecting a display change type of the sent virtual resource. If the display change type is different, the factor determining the form of the virtual resource is different. An effect is achieved that virtual resources in a different display form can be given out without requiring the user to select a specific form, richness and playability of live streaming gifts are increased, and an experience effect of giving a gift by the user in the live streaming is further improved.

According to the solution for interaction in a live streaming provided in the examples of the disclosure, in response to a sending operation on a target virtual resource on a live streaming interface, at least one display change type corresponding to the target virtual resource is displayed; in response to a selecting operation on a target display change type in the at least one display change type, a display change policy and current association information corresponding to the target display change type are obtained; and the target virtual resource is sent to a user in the live streaming, and the target virtual resource is displayed on the live streaming interface based on the display change policy according to the current association information of the target display change type. The live streaming interface is displayed on a current client side, a live streaming side and other client sides. By using the technical solution, at least one display change type corresponding to the sending operation on the target virtual resource by the user on the live streaming interface can be displayed. Then the current association information and the display change policy of the target display change type selected from the at least one display change type are obtained. The target virtual resource is sent to the user in the live streaming, and the target virtual resource is displayed based on the display change policy according to the current association information of the target display change type. In a live streaming scenario, by setting the display change type for the user to select, the user can decide a change manner of the sent virtual resource during display. Compared with the related art, when the virtual resource is sent, multi-form display can be implemented according to a form change manner determined by the user, such that diversity, richness and interest of giving a gift by the user in the live streaming are enhanced, and an interactive experience effect in the live streaming is further improved.

In some examples, the method for interaction in a live streaming may further include: when the current display attribute is a preset attribute, an attribute value of a current user to a streamer user and/or preset live streaming data of the streamer user are/is increased.

The preset attribute may be a display attribute with a special meaning set for the target virtual resource. For example, the target virtual resource is a virtual rose, and then the preset attribute may be red in color. When the preset attribute appears, some values may be increased for the current user or the streamer user. The preset live streaming data may be one of pieces of live streaming data of the streamer user, and may be specifically set according to an actual situation. For example, the preset live streaming data may be a popularity value of the streamer user.

Specifically, after the target virtual resource is displayed, the apparatus for interaction in a live streaming may determine whether the current display attribute of the target virtual resource is the preset attribute. If so, the attribute value of the current user to the streamer user and/or the preset live streaming data of the streamer user may be increased, and a specific increased value may be set according to actual conditions. For example, it may be doubled. That is to say, the attribute value of the current user to the streamer user and/or the preset live streaming data of the streamer user may be increased to double values. By increasing and adjusting some attribute values of the current user or the streamer user when the preset attribute of the virtual resource appears, the diversity and playability of giving a virtual resource in a live streaming scenario are further improved, and the experience effect of giving a gift in the live streaming is improved.

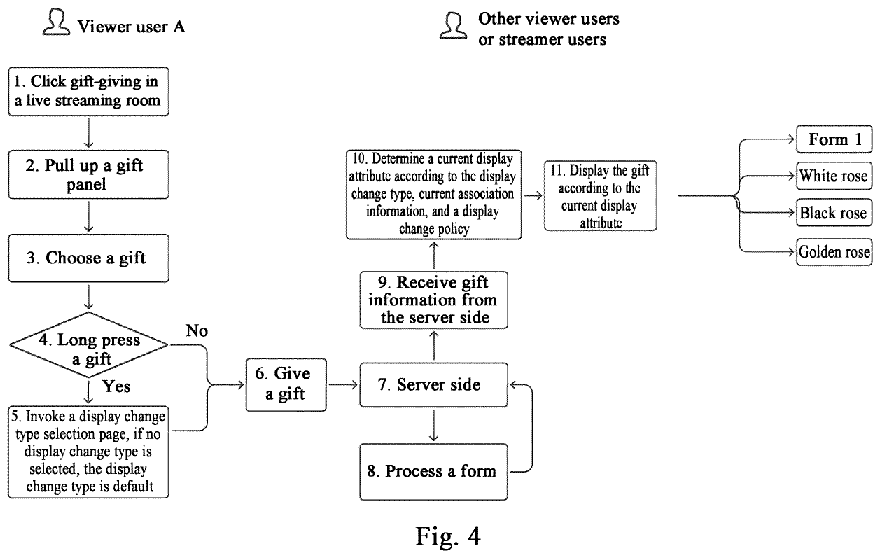

Next, the method for interaction in a live streaming according to the example of the disclosure is further described through a specific instance. Illustratively, FIG. 4 is a schematic diagram of an interaction process in a live streaming according to an example of the disclosure. As shown in FIG. 4, for example, a viewer user A in the figure is taken as a current viewer user, a virtual resource is characterized by a gift, and a specific process may include an operation process of the viewer user A and an operation process of other viewer users or a streamer user.

The operation process of the viewer user A may include: 1. The viewer user A clicks a gift giving control on a live streaming interface of a live room. 2. A gift panel is invoked, and the gift panel may include a plurality of virtual resources. 3. The viewer user A selects a gift to be given, such as selects a virtual rose. 4. In a case that the viewer user A performs a long press on the gift, a display change type selection page of the gift may be invoked on the gift panel. The display change type selection page includes at least one display change type of the gift. Then step 5 is performed. In a case that the viewer user A does not perform a long press on the gift, step 6 is directly performed, and a current display attribute of the gift is a default attribute. 5. For the at least one display change type, the viewer user A determines a target display change type by performing a selecting operation on one of the display change types. 6. A gift-giving operation is performed, a server side is requested, and form parameters are added. The form parameters include a target display change type and current association information corresponding to the target display change type. For example, the target display change type may be represented by a specific field. 7. The server side receives the form parameters sent by a client side of the viewer user A. 8. Form processing is added in the server side. The target display change type and a display change policy corresponding to the current association information corresponding to the target display change type are obtained according to the form parameters. The target display change type, the current association information corresponding to the target display change type, and the display change policy are sent as gift information to the client side of the viewer user A, client sides of the other viewer users, and a streamer side of the streamer user. 9. When the gift is displayed on live streaming interfaces of the client side of the viewer user A, the client sides of the other viewer users, and the streamer side of the streamer user, a current display attribute is determined according to the display change type, the current association information, and the display change policy in the gift information. 11. The client side of the viewer user A, the client sides of the other viewer users, and the streamer side of the streamer user display the gift according to the current display attribute.

According to the disclosure, a multi-form function of a gift in the gift-gifting during the live streaming is added, and a specific multi-form display change type may be selected, such that not only the gift in the gift-gifting during the live streaming can have specific different forms, but also change manners of the different forms can be decided by the selection of the user, and the interactive experience effect of giving a gift by the user in the live streaming is improved.

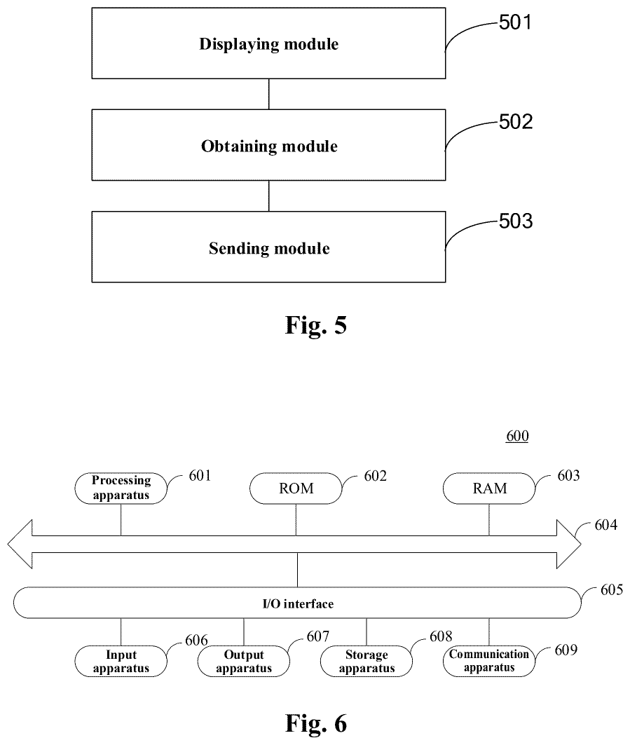

FIG. 5 is a schematic structural diagram of an apparatus for interaction in a live streaming according to an example of the disclosure. The apparatus may be implemented by software and/or hardware, and may generally be integrated into an electronic device. As shown in FIG. 5, the apparatus includes:
a displaying module 501 configured to display; in response to a sending operation on a target virtual resource on a live streaming interface, at least one display change type corresponding to the target virtual resource;
an obtaining module 502 configured to obtain, in response to a selecting operation on a target display change type in the at least one display change type, a display change policy and current association information corresponding to the target display change type; and
a sending module 503 configured to send the target virtual resource to a user in the live streaming, and display the target virtual resource on the live streaming interface based on the display change policy according to the current association information of the target display change type.

Optionally; the display change type includes at least one of the following: time, relation information between a viewer user and a streamer user, live streaming information of the streamer user, and randomization.

Optionally; in a case that the target display change type is the time, the current association information is a time point at which the sending operation on the target virtual resource is performed:
in a case that the target display change type is the relation information between the viewer user and the streamer user, the current association information includes a current attribute value of a current viewer user to the streamer user and/or current subscription information of the current viewer user to the streamer user; and
in a case that the target display change type is the live streaming information of the streamer user, the current association information is current live streaming data of the streamer user.

Optionally; the display change policy is configured to set a display attribute of the target virtual resource corresponding to at least one piece of association information of each display change type.

Optionally, the sending module 503 is configured to:
search in the display change policy according to the current association information of the target display change type, and extract a current display attribute of a target virtual resource corresponding to the current association information; and
display the target virtual resource according to the current display attribute.

Optionally; the apparatus further includes an increase module configured to:
increase, when the current display attribute is a preset attribute, an attribute value of a current user to a streamer user and/or preset live streaming data of the streamer user.

Optionally, the display attribute of the target virtual resource includes at least one of the following: color, transparency; brightness, and display style of at least one sub-area.

The apparatus for interaction in a live streaming according to the example of the disclosure may execute the method for interaction in a live streaming according to any example of the disclosure, and has corresponding functional modules and beneficial effects for executing the method.

A computer program product is further provided in an example of the disclosure. The computer program product includes a computer program/instruction, where the computer program/instruction implements the method for interaction in a live streaming according to any example of the disclosure when executed by a processor.

FIG. 6 is a schematic structural diagram of an electronic device according to an example of the disclosure.

FIG. 6 is a schematic structural diagram suitable for implementing an electronic device 600 in an example of the disclosure, which is specifically referred below. The electronic device 600 in the example of the disclosure may include, but is not limited to, mobile terminals such as a mobile phone, a notebook computer, a digital broadcasting receiver, a personal digital assistant (PDA), a portable android device (PAD), a portable multimedia player (PMP), an in-vehicle terminal (for example, an in-vehicle navigation terminal), etc., and fixed terminals such as a digital television (TV), a desktop computer, etc. The electronic device illustrated in FIG. 6 is merely an instance and should not impose any limitation on the functions and scope of use of the examples of the disclosure.

As shown in FIG. 6, the electronic device 600 may include a processing apparatus (for example, a central processing unit, and a graphics processing unit) 601 that may execute various appropriate actions and processes according to programs stored in a read-only memory (ROM) 602 or programs loaded from a storage apparatus 608 into a random-access memory (RAM) 603. The RAM 603 also stores various programs and data needed for the operations of the electronic device 600. The processor 601, the ROM 602, and the RAM 603 are connected to each other by means of a bus 604. An input/output (I/O) interface 605 is also connected to the bus 604.

Typically, the I/O interface 605 may be connected to the following apparatuses: an input apparatus 606 such as a touch screen, a touch pad, a keyboard, a mouse, a camera, a microphone, an accelerometer, and a gyroscope; an output apparatus 607 such as a liquid crystal display (LCD), a speaker, and a vibrator; a storage apparatus 608 such as a magnetic tape and a hard disk; and a communication apparatus 609. The communication apparatus 609 may allow the electronic device 600 to be in wireless or wired communication with other devices to exchange data. While the FIG. 6 illustrates an electronic device 600 having various apparatuses, it should be understood that not all of the illustrated apparatuses are required to be implemented or provided. More or fewer apparatuses may alternatively be implemented or provided.

In particular, according to examples of the disclosure, processes described above with reference to the flowcharts may be implemented as a computer software program. For example, examples of the disclosure include a computer program product. The computer program product includes a computer program carried on a non-transitory computer-readable medium, and the computer program includes a program code for executing the method illustrated in the flowchart. In such examples, the computer program may be downloaded and installed from a network by means of the communication apparatuses 609, or installed from the storage apparatus 608, or installed from the ROM 602. The computer program executes the above functions defined in the method for interaction in a live streaming in the example of the disclosure when executed by the processor 601.

It should be noted that the computer-readable medium in the disclosure may be a computer-readable signal medium or a computer-readable storage medium, or any combination of a computer-readable signal medium and a computer-readable storage medium. The computer-readable storage medium may include, but is not limited to, an electronic, magnetic, optical, electromagnetic, infrared, or semiconductor system, apparatus, or device, or any combination of the foregoing. More specific instance of the computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the disclosure, the computer-readable storage medium may be any tangible medium that includes or stores a program for use by or in conjunction with an instruction execution system, apparatus, or device. In the disclosure, the compute-readable signal medium may include a data signal propagating in a baseband or as part of a carry wave and carrying a computer-readable program code. Such a propagated data signal may have a variety of forms and may include, but is not limited to, an electromagnetic signal, an optical signal, or any suitable combination of the foregoing. The computer-readable signal medium may also be any computer-readable medium besides a computer-readable storage medium. The computer-readable signal medium can send, propagate, or transfer a program for use by or in conjunction with an instruction execution system, apparatus, or device. A program code included on a computer-readable medium may be transferred by means of any suitable medium, including, but not limited to, wires, fiber optic cables, radio frequency (RF), etc., or any suitable combination of the foregoing.

In some embodiments, a client side and a server may communicate by using any currently known or future developed network protocol, such as a hypertext transfer protocol (HTTP), and may be interconnected with any form or medium of digital data communication (for example, a communication network). Instances of communication networks include a local area network (LAN), a wide area network (WAN). Internet work (for example, the Internet), and an end-to-end network (for example, an ad hoc end-to-end network), as well as any currently known or future developed network.

The computer-readable medium may be included in the above electronic device, and may also exist independently without being assembled into the electronic device.

The above computer-readable medium carries one or more programs. When executed by the electronic device, the above one or more programs cause the electronic device to: display; in response to a sending operation on a target virtual resource on a live streaming interface, at least one display change type corresponding to the target virtual resource; obtain, in response to a selecting operation on a target display change type in the at least one display change type, a display change policy and current association information corresponding to the target display change type; and send the target virtual resource to a user in the live streaming, and display the target virtual resource on the live streaming interface based on the display change policy according to the current association information of the target display change type.

A computer program code for executing operations of the disclosure may be written in one or more programming languages, or combinations of the programming languages. The programming languages include, but are not limited to, object-oriented programming languages, such as Java. Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected with a user computer through any kind of network, including a local area network (LAN) or a wide area network (WAN), or may be connected with an external computer (for example, connected through the Internet by using an Internet service provider).

The flowcharts and block diagrams in the accompanying drawings illustrate the architecture, functionality; and operations possibly implemented by the systems, methods, and computer program products according to various examples of the disclosure. In this regard, each block in the flowcharts or block diagrams may represent a module, a program segment, or part of a code, and a module, a program segment, or part of a code includes one or more executable instructions for implementing a specified logical function. It should also be noted that in some alternative implementations, a function noted in a block may occur in a different order than an order noted in the figures. For example, two consecutive blocks may actually be executed substantially in parallel, or in a reverse order sometimes, depending on a function involved. It should also be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The units described in the example of the disclosure may be implemented in software or hardware. The name of a unit does not constitute a qualification of the unit itself under certain circumstances.

The functions described above herein may be executed at least partially by one or more hardware logic components. For example, exemplary types of the hardware logic components that may be used include: a field programmable gate array (FPGA), an application specific integrated circuit (ASIC), an application specific standard product (ASSP), a system on chip (SOC), a complex programmable logic device (CPLD), etc. in a non-restrictive way.

In the context of the disclosure, the machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific instance of the machine-readable storage medium may include an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

It can be understood that before the technical solutions disclosed in examples of the disclosure are used, a user should be notified of a type, use scope, use scenario, etc. of information involved in the disclosure in an appropriate manner according to relevant laws and regulations, and authorization from the user should be acquired.

The above description is merely illustrative of preferred examples of the disclosure and principles of the technology employed. It should be understood by those skilled in the art that the disclosed scope involved in the disclosure is not limited to the technical solutions in which the above-described technical features are specifically combined, but encompasses other technical solutions in which the above-described technical features or equivalent features thereof are arbitrarily combined without departing from the concept of the disclosure, for example, technical solutions formed by interchanging the features described above with (non-limitative) technical features disclosed in the disclosure that have similar functions.

Furthermore, although operations are depicted in a particular order, this should not be understood as requiring that such operations be executed in the particular order shown or in a sequential order. In certain circumstances, multitasking and parallel processing may be advantageous. Similarly: although several specific implementation details are included in the above discussion, these details should not be construed as limitations on the scope of the disclosure. Some features that are described in the context of separate examples may also be implemented in combination in a single example. On the contrary, various features described in the context of a single example can also be implemented in multiple examples separately or in any suitable sub-combination manner.

Although the subject matter has been described in language specific to structural features and/or methodological logical actions, it should be understood that the subject matter defined in the appended claims is not necessarily limited to the specific features or actions described above. On the contrary, the specific features and actions described above are merely instance forms of implementing the claims.

I/We claim:

1. A method for interaction in a live streaming, comprising:
displaying, in response to a sending operation on a target virtual resource on a live streaming interface, at least one display change type corresponding to the target virtual resource;
obtaining, in response to a selecting operation on a target display change type in the at least one display change type, a display change policy and current association information corresponding to the target display change type; and
sending the target virtual resource to a user in the live streaming, and displaying the target virtual resource on the live streaming interface based on the display change policy according to the current association information of the target display change type.

2. The method according to claim 1, wherein the display change type comprises at least one of the following: time, relation information between a viewer user and a streamer user, live streaming information of the streamer user, and randomization.

3. The method according to claim 2, wherein in a case that the target display change type is the time, the current association information is a time point at which the sending operation on the target virtual resource is performed;
in a case that the target display change type is the relation information between the viewer user and the streamer user, the current association information comprises a current attribute value of a current viewer user to the streamer user, and/or current subscription information of the current viewer user to the streamer user; and
in a case that the target display change type is the live streaming information of the streamer user, the current association information is current live streaming data of the streamer user.

4. The method according to claim 1, wherein the display change policy is configured to set a display attribute of the target virtual resource corresponding to at least one piece of association information of each display change type.

5. The method according to claim 4, wherein displaying the target virtual resource on the live streaming interface of a current client side based on the display change policy according to the current association information of the target display change type comprises:
searching in the display change policy according to the current association information of the target display change type, and extracting a current display attribute of a target virtual resource corresponding to the current association information; and
displaying the target virtual resource according to the current display attribute.

6. The method according to claim 5, further comprising:
increasing, in response to the current display attribute being a preset attribute, an attribute value of a current user to a streamer user, and/or preset live streaming data of the streamer user.

7. The method according to claim 4, wherein the display attribute of the target virtual resource comprises at least one of the following: color, transparency, brightness, or display style of at least one sub-area.

8. An electronic device, comprising:
a processor, and
a memory configured to store processor-executable instructions, wherein the processor-executable instructions, when executed by the processor, cause the processor to:
display, in response to a sending operation on a target virtual resource on a live streaming interface, at least one display change type corresponding to the target virtual resource;
obtain, in response to a selecting operation on a target display change type in the at least one display change type, a display change policy and current association information corresponding to the target display change type; and
send the target virtual resource to a user in the live streaming, and display the target virtual resource on the live streaming interface based on the display change policy according to the current association information of the target display change type.

9. The electronic device according to claim 8, wherein the display change type comprises at least one of the following: time, relation information between a viewer user and a streamer user, live streaming information of the streamer user, and randomization.

10. The electronic device according to claim 9, wherein in a case that the target display change type is the time, the current association information is a time point at which the sending operation on the target virtual resource is performed;
in a case that the target display change type is the relation information between the viewer user and the streamer user, the current association information comprises a current attribute value of a current viewer user to the streamer user, and/or current subscription information of the current viewer user to the streamer user; and
in a case that the target display change type is the live streaming information of the streamer user, the current association information is current live streaming data of the streamer user.

11. The electronic device according to claim 8, wherein the display change policy is configured to set a display attribute of the target virtual resource corresponding to at least one piece of association information of each display change type.

12. The electronic device according to claim 11, wherein the processor-executable instructions further cause the processor to:
search in the display change policy according to the current association information of the target display change type, and extract a current display attribute of a target virtual resource corresponding to the current association information; and
display the target virtual resource according to the current display attribute.

13. The electronic device according to claim 12, wherein the processor-executable instructions further cause the processor to:
increase, in response to the current display attribute being a preset attribute, an attribute value of a current user to a streamer user, and/or preset live streaming data of the streamer user.

14. The electronic device according to claim 11 wherein the display attribute of the target virtual resource comprises at least one of the following: color, transparency, brightness, or display style of at least one sub-area.

15. A non-transitory computer-readable storage medium, storing a computer program, wherein the computer program, when executed by a processor, causes the processor to:
display, in response to a sending operation on a target virtual resource on a live streaming interface, at least one display change type corresponding to the target virtual resource;
obtain, in response to a selecting operation on a target display change type in the at least one display change type, a display change policy and current association information corresponding to the target display change type; and
send the target virtual resource to a user in the live streaming, and display the target virtual resource on the live streaming interface based on the display change policy according to the current association information of the target display change type.

16. The non-transitory computer-readable storage medium according to claim 15, wherein the display change type comprises at least one of the following: time, relation information between a viewer user and a streamer user, live streaming information of the streamer user, and randomization.

17. The non-transitory computer-readable storage medium according to claim 16, wherein in a case that the target display change type is the time, the current association information is a time point at which the sending operation on the target virtual resource is performed:
in a case that the target display change type is the relation information between the viewer user and the streamer user, the current association information comprises a current attribute value of a current viewer user to the streamer user, and/or current subscription information of the current viewer user to the streamer user; and
in a case that the target display change type is the live streaming information of the streamer user, the current association information is current live streaming data of the streamer user.

18. The non-transitory computer-readable storage medium according to claim 15, wherein the display change policy is configured to set a display attribute of the target virtual resource corresponding to at least one piece of association information of each display change type.

19. The non-transitory computer-readable storage medium according to claim 18, wherein the computer program further causes the processor to:
search in the display change policy according to the current association information of the target display change type, and extract a current display attribute of a target virtual resource corresponding to the current association information; and
display the target virtual resource according to the current display attribute.

20. The non-transitory computer-readable storage medium according to claim 19, wherein the computer program further causes the processor to:
increase, in response to the current display attribute being a preset attribute, an attribute value of a current user to a streamer user, and/or preset live streaming data of the streamer user.
